(19) United States
(12) Patent Application Publication
(10) Pub. No.: US 2015/0200846 A1
(43) Pub. Date: Jul. 16, 2015

(54) DATA RATE SELECTION WITH PROACTIVE ROUTING IN SMART GRID NETWORKS

(71) Applicant: Cisco Technology, Inc., San Jose, CA (US)

(72) Inventors: Jonathan W. Hui, Belmont, CA (US); Wei Hong, Berkeley, CA (US); Jean-Philippe Vasseur, Saint Martin d'Uriage (FR)

(73) Assignee: Cisco Technology, Inc., San Jose, CA (US)

(21) Appl. No.: 14/155,975

(22) Filed: Jan. 15, 2014

(51) Int. Cl. H04L 12/721; H04L 12/751; H04L 12/715

(52) U.S. Cl. CPC H04L 45/70; H04L 45/26; H04L 45/46; H04L 45/02

(57) ABSTRACT

In one embodiment, a device communicates with one or more neighboring devices in a shared-media communication network using a default data rate. The device determines that the default data rate is not supported by a particular one of the neighboring devices. The particular neighboring device is then associated with a second data rate that has a lower data rate than the default data rate. The second data rate is then used to communicate with the particular neighboring device.

### TECHNICAL FIELD

The present disclosure relates generally to computer networks, and, more particularly, to data rate selection for smart grid networks that use proactive routing techniques.

### BACKGROUND

Low power and Lossy Networks (LLNs), e.g., sensor networks, have a myriad of applications, such as Smart Grid (smart metering), home and building automation, smart cities, etc. Various challenges are presented with LLNs, such as lossy links, low bandwidth, battery operation, low memory and/or processing capability, etc. For instance, LLNs communicate over a physical medium that is strongly affected by environmental conditions that change over time, and often use low-cost and low-power transceiver designs with limited capabilities (e.g., low throughput and limited link margin).

Current routing approaches used in LLNs generally take a conservative approach to selecting a data rate. In general, this is because slower data rates offer a more robust transmission strategy in LLNs. For example, a Tone Mapping Request may be initially sent using a low data rate to a neighboring device, as part of an Adaptive Tone Mapping process. After a Tone Mapping Reply is received from the neighboring device, data regarding the neighbor is stored and a higher data transmission rate may then be used for subsequent communications. The stored data may also be purged after a certain amount of time and this process repeated as needed. This type of approach is particularly optimized for reactive networks that establish a path, send traffic data along the path, and then stop using the path for some time. However, reactive routing strategies may not operate well in large-scale LLNs that are typical for Smart Grid AMI solutions. Thus, current routing techniques such as RPL, as specified in RFC6550, used in LLNs offer room for improvement.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example communication network;

FIG. 2 illustrates an example network node/device;

FIG. 3 illustrates an example view of a node/device sending messages using a high data rate;

FIG. 4 illustrates an example view of a node/device sending messages using a low data rate;

FIG. 5 illustrates an example view of different data rates in the communication network;

FIG. 6 illustrates an example view of a cluster of low data rate devices;

FIG. 7 illustrates an example procedure for selecting a data rate for a neighboring node/device; and

FIG. 8 illustrates an example procedure for promulgating a default data rate in a shared-media communication network.

### DESCRIPTION OF EXAMPLE EMBODIMENTS

### Overview

According to one or more embodiments of the disclosure, a device communicates with one or more neighboring devices in a shared-media communication network using a default data rate. The device determines that the default data rate is not supported by a particular one of the neighboring devices. The particular neighboring device is associated with a second data rate that has a lower data rate than the default data rate. The second data rate is then used to communicate with the particular neighboring device.

According to one or more additional embodiments of the disclosure, a root node device receives neighbor table data from a plurality of devices in a shared-media communication network, the neighbor table data comprising data rates between the devices. The root node device may then determine a default data rate using the neighbor table data, and provides the default data rate to the plurality of devices.

### DESCRIPTION

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, or Powerline Communications (PLC) such as IEEE 61334, IEEE P1901.2, and others. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), etc. Generally, size and cost constraints on smart object nodes (e.g., sensors) result in corresponding constraints on resources such as energy, memory, computational speed and bandwidth.

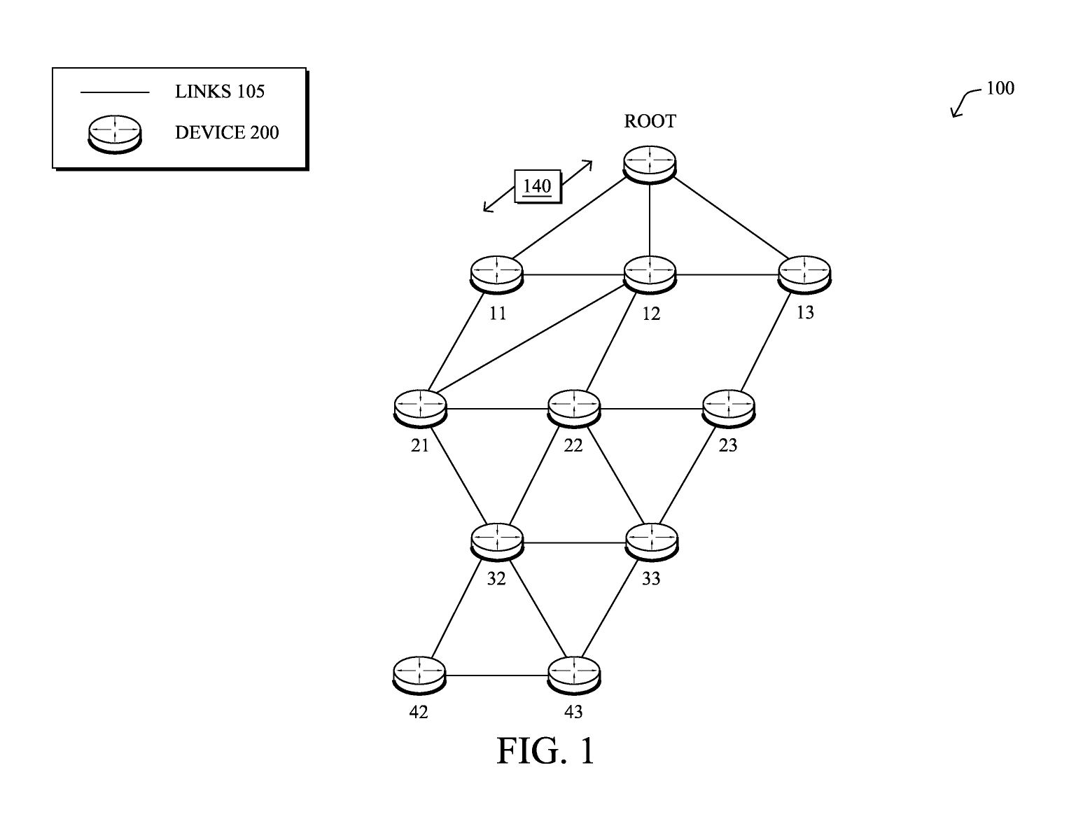

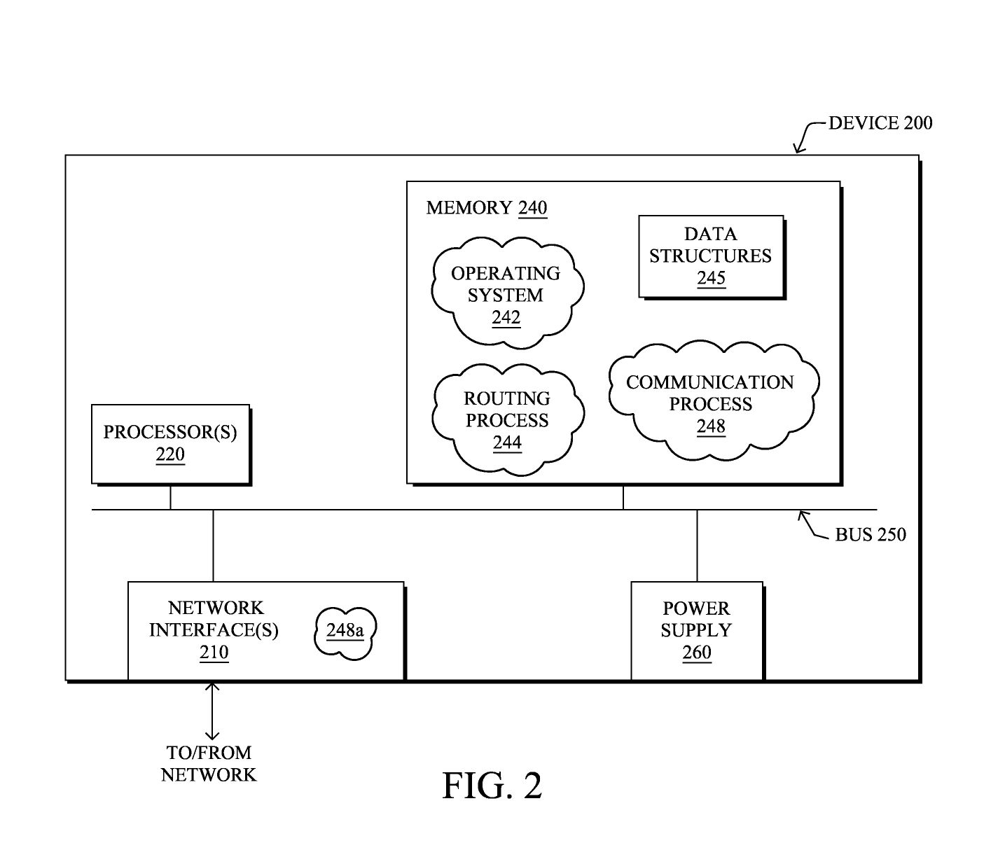

FIG. 1 is a schematic block diagram of an example computer network 100 illustratively comprising nodes/devices 200 (e.g., labeled as shown, “root,” “11,” “12,” . . . “45,” and described in FIG. 2 below) interconnected by various methods of communication. For instance, the links 105 may be wired links or shared media (e.g., wireless links, PLC links, etc.) where certain nodes 200, such as, e.g., routers, sensors, computers, etc., may be in communication with other nodes 200, e.g., based on distance, signal strength, current operational status, location, etc. Those skilled in the art will understand that any number of nodes, devices, links, etc. may be used in the computer network, and that the view shown herein is for simplicity. Also, those skilled in the art will further understand that while the network is shown in a certain orientation, particularly with a “root” node, the network 100 is merely an example illustration that is not meant to limit the disclosure.

Data packets 140 (e.g., traffic and/or messages sent between the nodes/devices) may be exchanged among the nodes/devices of the computer network 100 using predefined network communication protocols such as certain known wired protocols, wireless protocols (e.g., IEEE Std. 802.15.4, WiFi, Bluetooth®, etc.), PLC protocols, or other shared-media protocols where appropriate. In this context, a protocol consists of a set of rules defining how the nodes interact with each other.

FIG. 2 is a schematic block diagram of an example node/device 200 that may be used with one or more embodiments described herein, e.g., as any of the nodes shown in FIG. 1 above. The device may comprise one or more network interfaces 210 (e.g., wired, wireless, PLC, etc.), at least one processor 220, and a memory 240 interconnected by a system bus 250, as well as a power supply 260 (e.g., battery, plug-in, etc.).

The network interface(s) 210 contain the mechanical, electrical, and signaling circuitry for communicating data over links 105 coupled to the network 100. The network interfaces may be configured to transmit and/or receive data using a variety of different communication protocols. Note, further, that the nodes may have two different types of network connections 210, e.g., wireless and wired/physical connections, and that the view herein is merely for illustration. Also, while the network interface 210 is shown separately from power supply 260, for PLC the network interface 210 may communicate through the power supply 260, or may be an integral component of the power supply. In some specific configurations the PLC signal may be coupled to the power line feeding into the power supply.

The memory 240 comprises a plurality of storage locations that are addressable by the processor 220 and the network interfaces 210 for storing software programs and data structures associated with the embodiments described herein. Note that certain devices may have limited memory or no memory (e.g., no memory for storage other than for programs/processes operating on the device and associated caches). The processor 220 may comprise hardware elements or hardware logic adapted to execute the software programs and manipulate the data structures 245. An operating system 242, portions of which are typically resident in memory 240 and executed by the processor, functionally organizes the device by, inter alia, invoking operations in support of software processes and/or services executing on the device. These software processes and/or services may comprise routing process/services 244 and an illustrative communication process 248, as described herein. Note that while communication process 248 is shown in centralized memory 240, alternative embodiments provide for the process to be specifically operated within the network interfaces 210 (process “248a”).

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while the processes have been shown separately, those skilled in the art will appreciate that processes may be routines or modules within other processes.

Routing process (services) 244 contains computer executable instructions executed by the processor 220 to perform functions provided by one or more routing protocols, such as proactive or reactive routing protocols as will be understood by those skilled in the art. These functions may, on capable devices, be configured to manage a routing/forwarding table (a data structure 245) containing, e.g., data used to make routing/forwarding decisions. In particular, in proactive routing, connectivity is discovered and known prior to computing routes to any destination in the network, e.g., link state routing such as Open Shortest Path First (OSPF), or Intermediate-System-to-Intermediate-System (ISIS), or Optimized Link State Routing (OLSR). Reactive routing, on the other hand, discovers neighbors (i.e., does not have an a priori knowledge of network topology), and in response to a needed route to a destination, sends a route request into the network to determine which neighboring node may be used to reach the desired destination. Example reactive routing protocols may comprise Ad-hoc On-demand Distance Vector (AODV), Dynamic Source Routing (DSR), DYnamic MANET On-demand Routing (DYMO), etc. Notably, on devices not capable or configured to store routing entries, routing process 244 may consist solely of providing mechanisms necessary for source routing techniques. That is, for source routing, other devices in the network can tell the less capable devices exactly where to send the packets, and the less capable devices simply forward the packets as directed.

Notably, mesh networks have become increasingly popular and practical in recent years. In particular, shared-media mesh networks, such as wireless or PLC networks, etc., are often on what is referred to as LLNs, which are a class of network in which both the routers and their interconnect are constrained: LLN routers typically operate with constraints, e.g., processing power, memory, and/or energy (battery), and their interconnects are characterized by, illustratively, high loss rates, low data rates, and/or instability. LLNs are comprised of anything from a few dozen and up to thousands or even millions of LLN routers, and support point-to-point traffic (between devices inside the LLN), point-to-multipoint traffic (from a central control point such at the root node to a subset of devices inside the LLN) and multipoint-to-point traffic (from devices inside the LLN towards a central control point).

An example implementation of LLNs is an “Internet of Things” network. Loosely, the term “Internet of Things” or “IoT” may be used by those in the art to refer to uniquely identifiable objects (things) and their virtual representations in a network-based architecture. In particular, the next frontier in the evolution of the Internet is the ability to connect more than just computers and communications devices, but rather the ability to connect “objects” in general, such as lights, appliances, vehicles, HVAC (heating, ventilating, and air-conditioning), windows and window shades and blinds, doors, locks, etc. The “Internet of Things” thus generally refers to the interconnection of objects (e.g., smart objects), such as sensors and actuators, over a computer network (e.g., IP), which may be the Public Internet or a private network. Such devices have been used in the industry for decades, usually in the form of non-IP or proprietary protocols that are connected to IP networks by way of protocol translation gateways. With the emergence of a myriad of applications, such as the smart grid, smart cities, and building and industrial automation, and cars (e.g., that can interconnect millions of objects for sensing things like power quality, tire pressure, and temperature and that can actuate engines and lights), it has been of the utmost importance to extend the IP protocol suite for these networks.

An example proactive routing protocol specified in an Internet Engineering Task Force (IETF) Proposed Standard, Request for Comment (RFC) 6550, entitled “RPL: IPv6 Routing Protocol for Low Power and Lossy Networks” by Winter, et al. (March 2012), provides a mechanism that supports multipoint-to-point (MP2P) traffic from devices inside the LLN towards a central control point (e.g., LLN Border Routers (LBRs) or “root nodes/devices” generally), as well as point-to-multipoint (P2MP) traffic from the central control point to the devices inside the LLN (and also point-to-point, or “P2P” traffic). RPL (pronounced “ripple”) may generally be described as a distance vector routing protocol that builds a Directed Acyclic Graph (DAG) for use in routing traffic/packets 140, in addition to defining a set of features to bound the control traffic, support repair, etc. Notably, as may be appreciated by those skilled in the art, RPL also supports the concept of Multi-Topology-Routing (MTR), whereby multiple DAGs can be built to carry traffic according to individual requirements.

Also, a directed acyclic graph (DAG) is a directed graph having the property that all edges are oriented in such a way that no cycles (loops) are supposed to exist. All edges are contained in paths oriented toward and terminating at one or more root nodes (e.g., “clusterheads or “sinks”), often to interconnect the devices of the DAG with a larger infrastructure, such as the Internet, a wide area network, or other domain. In addition, a Destination Oriented DAG (DODAG) is a DAG rooted at a single destination, i.e., at a single DAG root with no outgoing edges. A “parent” of a particular node within a DAG is an immediate successor of the particular node on a path towards the DAG root, such that the parent has a lower “rank” than the particular node itself, where the rank of a node identifies the node's position with respect to a DAG root (e.g., the farther away a node is from a root, the higher is the rank of that node). Note also that a tree is a kind of DAG, where each node/device in the DAG generally has one parent or one preferred parent. DAGs may generally be built (e.g., by DAG process 246 and/or routing process 244) based on an Objective Function (OF). The role of the Objective Function is generally to specify rules on how to build the DAG (e.g. number of parents, backup parents, etc.).

As noted, though, LLNs face a number of communication challenges:
1) LLNs communicate over a physical medium that is strongly affected by environmental conditions that change over time. Some examples include temporal changes in interference (e.g., other wireless networks or electrical appliances), physical obstruction (e.g., doors opening/closing or seasonal changes in foliage density of trees), and propagation characteristics of the physical media (e.g., temperature or humidity changes). The time scales of such temporal changes can range between milliseconds (e.g. transmissions from other transceivers) to months (e.g. seasonal changes of outdoor environment).
2) Low-cost and low-power designs limit the capabilities of the transceiver. In particular, LLN transceivers typically provide low throughput. Furthermore, LLN transceivers typically support limited link margin, making the effects of interference and environmental changes visible to link and network protocols.

To help provide greater throughput and robustness in an LLN, Adaptive Tone Mapping may be used to dynamically select which subcarriers and coding parameters are used when transmitting a data frame. The goal of Adaptive Tone Mapping is to maximize throughput and minimize channel utilization by only transmitting on usable subcarriers and optimizing the code-rate without sacrificing robustness.

IEEE P1901.2 is standardizing an Adaptive Tone Mapping process which seeks to optimize the link data rate to observed link conditions. By adjusting the transmission parameters (modulation, code rate, tone map), the effective throughput can range from 2.4 kbps to 34.2 kbps in the CENELEC A band, more than an order of magnitude in difference. In general, slower data rates offer a more robust transmission strategy. Thus, the current proposal in IEEE P1901.2 takes a very conservative approach to transmissions. All broadcast messages are sent using the slowest transmission mode (called “ROBO” mode for “robust operation” mode). When sending a unicast message to a neighbor that has no valid neighbor table entry, the message is sent using ROBO mode with the Tone Map Request (TMREQ) bit set. Upon receiving a Tone Map Reply (TMREP) from the neighbor, it creates a neighbor entry so that subsequent transmissions to the same neighbor can be sent using, hopefully, a faster data rate. However, associated with the neighbor entry is an age value and when the age exceeds a threshold, the neighbor entry is deleted. As a result, the next transmission to that neighbor again will occur using ROBO mode with the TMREQ bit set.

As noted above, reactive routing approaches used in LLNs generally take a conservative approach to selecting a data rate. In general, this is because slower data rates offer a more robust transmission strategy. However, reactive routing strategies may also not operate well in large-scale LLNs.

Data Rate Selection in Smart Grid Networks

Some large-scale LLNs, such as those typically used for Smart Grid AMI solutions, may be configured to use a proactive routing strategy instead of a reactive strategy. In other words, the network may be configured to proactively maintain routes for all devices using a low-rate, periodic reporting traffic model. In particular, the dominant traffic model for many devices in Smart Grid AMI networks is to periodically transmit messages towards the Field Area Router (FAR) with a relatively long period (e.g., every 30 minutes to several hours). Existing processes, such as the IEEE P1901.2 Adaptive Tone Mapping process, provide sub-optimal performance in these types of proactive routing systems. For example, such a low traffic rate may mean that the vast majority of traffic would be sent using ROBO mode. Furthermore, these types of packets would be sent with the TMREQ bit set, generating a TMREP providing transmission parameters that will be aged out before they are used again. Thus, the network would be wasting significant resources by sending data packets using ROBO mode and generating useless TMREP messages. Accordingly, current routing techniques for use in LLNs offer room for improvement.

There are a number of data rate adaptation techniques for various link technologies (e.g. WiFi, cellular, etc.). The goal is generally the same for these techniques, i.e., maximizing the overall throughput given the observed link conditions. However, when compared to Smart Grid AMI networks, one significant difference is that these existing efforts typically addressed much higher data rates, and links are significantly less prone to failures and errors. The much higher data rate provides many more opportunities to observe and estimate link qualities as well as amortize the cost of any overhead needed to perform the rate adaptation. Another significant difference is that many of these methods are designed for star topologies, where a signal device is only concerned in communicating with a single neighbor (e.g. access point). Unlike star topologies, a given link in large-scale mesh networks affects the path of all routes that utilize that link. Hidden-terminal issues are much more significant since a single transmission affects devices both upstream and downstream of the path. Thus, these data rate adaptation techniques also fail to address the unique features of large-scale LLNs, such as Smart Grid AMI networks.

The techniques herein provide a method for improving rate adaptation in LLNs, and particularly for LLNs that utilize proactive routing approaches. In particular, one aspect of the described techniques involves having devices default to a high data rate when establishing a topology. The techniques also include dropping back to a lower data rate only when needed to establish connectivity or significantly improve the route cost. In another aspect, the techniques include having devices needing low-data rate links proactively maintain those links with routing adjacencies. A further aspect of the techniques described herein includes having routers transmit broadcasts using the lowest data rate of registered routing adjacencies. Yet another aspect of the described techniques involves encouraging devices needing low data rate links to cluster around the same set of routers. An additional aspect of the techniques disclosed herein includes reporting metrics and neighbor information to the DAG Root, allowing for dynamic adjustment of the default data rate based on network density, diameter, etc.

Operationally, the techniques described herein provide for an improved data rate adaptation mechanism where proactive routing is used in conjunction with a protocol such as IEEE P1901.2. Whereas G3 PLC uses reactive routing techniques to establish routes (e.g., using the LOAD protocol which has proven to operate poorly in these networks) proactive routing techniques may alternatively be used (e.g., by implementing the RPL routing protocol). In particular, the techniques described herein take a more optimistic approach and first attempt to establish routing adjacencies using higher data rates. A device then only resorts to using lower data rates if connectivity cannot be achieved in any other way or if it can significant improve its routing cost. The optimistic approaches described herein work particularly well in Smart Grid AMI networks that typically operate at large scale and higher densities. Not only does this minimize the need to use ROBO mode and initiate TMREQ/TMREP exchanges, this also significantly improves the convergence time of the network.

Specifically, according to one or more embodiments of the disclosure as described in detail below, a device communicates with one or more neighboring devices in shared-media communication network (e.g., an LLN) using a default data rate. The device determines that the default data rate is not supported by a particular one of the neighboring devices. The particular neighboring device is associated with a second data rate that has a lower data rate than the default data rate. The second data rate is then used to communicate with the particular neighboring device.

Illustratively, the techniques described herein may be performed by hardware, software, and/or firmware, such as in accordance with the communication process 248/248a, which may contain computer executable instructions executed by the processor 220 (or independent processor of interfaces 210) to perform functions relating to the techniques described herein, e.g., in conjunction with routing process 244. For example, the techniques herein may be treated as extensions to conventional protocols, such as the various PLC protocols or wireless communication protocols, and as such, may be processed by similar components understood in the art that execute those protocols, accordingly.

===Defaulting to a High Data Rate===

A first aspect of the techniques described herein involves setting the default data rate at the high end. This is in direct contrast to conservative approaches that set the default data rate to the slowest mode (e.g., IEEE P1901.2 uses ROBO by default, etc.). Preliminary test data shows that sending at low data rates is detrimental to overall performance. Low data rate transmissions occupy the channel for an order of magnitude longer and significantly increase the likelihood of collisions and the hidden-terminal problem. Defaulting to higher data rates builds on the fact that Smart Grid AMI networks typically operate at large scale and high densities. In other words, all broadcast transmissions and unicast transmissions to neighboring devices may be defaulted to high data rates, in one embodiment.

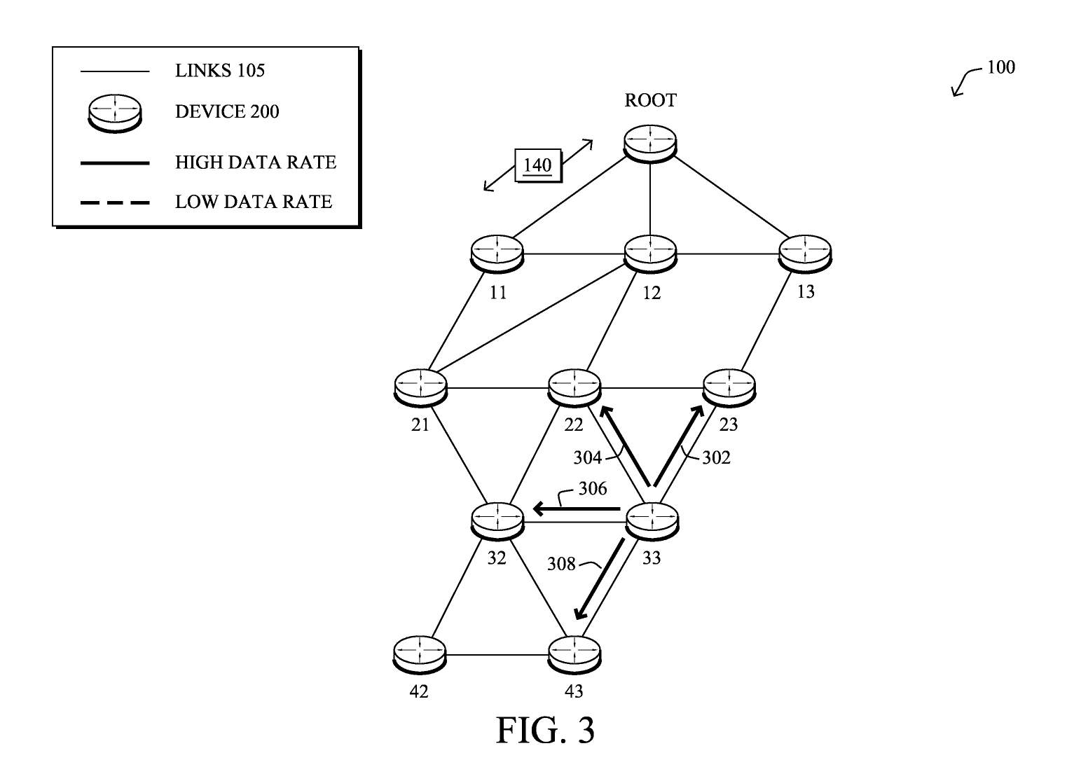

As shown in FIG. 3, according to one embodiment, a node/device 33 in network 100 may use a high data rate by default, to send one or more of transmissions 302-308 to any or all of neighboring nodes/devices 23, 22, 32, and 43, respectively. Transmissions 302-308 may be sent simultaneously, as in the case of broadcast transmissions, or on a one-by-one basis, in the case of unicast transmissions. For example, any or all of transmissions 302-308 may be Enhanced Beacon Requests (EBRs), TMREQs, routed data, messages propagated from the network's root node, etc.

As used herein, a “higher data rate mode” generally refers to any non-minimal data rate mode supported by a network. In Smart Grid AMI applications, this may correspond to any data rate mode that sacrifices robustness for a higher data transmission rate. For example, if network 100 is a P1901.2 network, binary phase shift keying (BPSK) or quadrature phase shift keying (QPSK) may be used by default for transmissions 302-308, in contrast to modulating transmissions 302-308 using ROBO. In one embodiment, the default for network 100 may be fixed to the highest possible data rate supported by the network. In another embodiment, the default may be a configurable parameter.

===Link Discovery using a Low Data Rate===

A second aspect of the techniques described herein involves having a low data rate process to discover long links when they are needed.

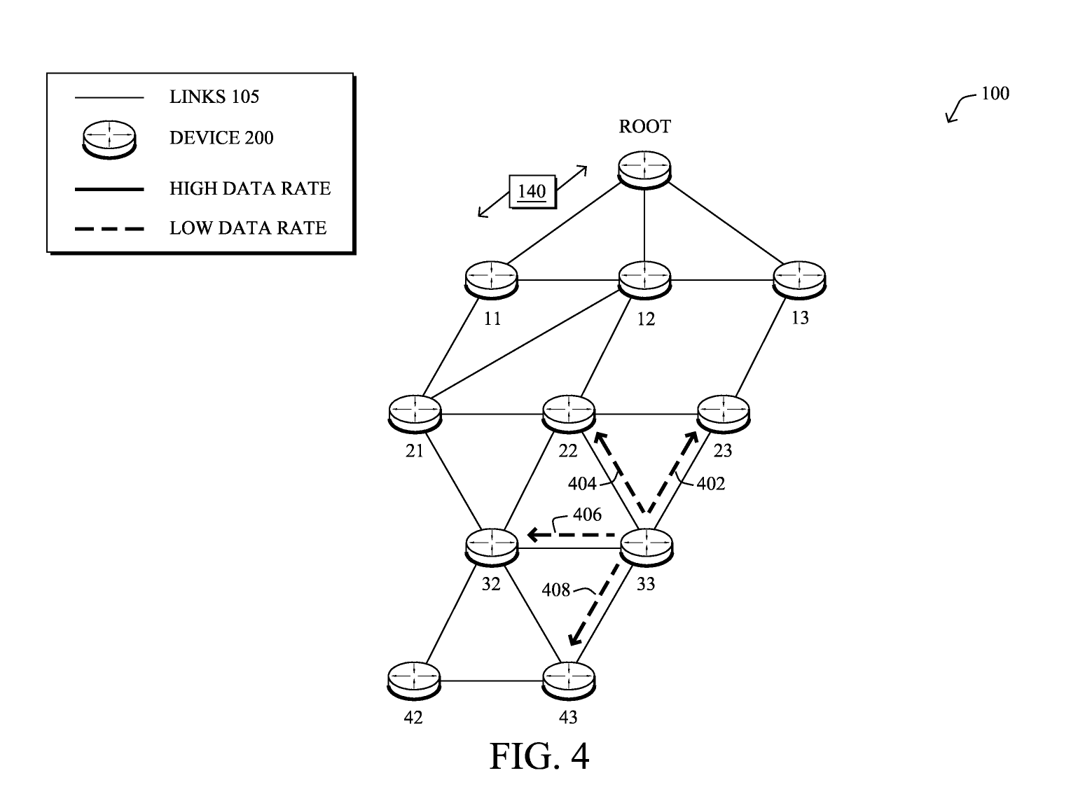

Referring still to FIG. 3, assume that transmissions 302-308 are EBRs sent by node/device 33 to discover neighboring devices in network 100. In one embodiment, as depicted in FIG. 4, node/device 33 may transmit EBRs 402-408 at a lower data rate if it is unable to discover any neighboring devices via transmissions 302-308. For example, if device/node 33 cannot discover any neighbors using a high data rate mode such as QPSK, it may begin sending EBRs using BPSK, to broaden its search range. Any neighboring devices receiving the EBR should respond using the same data rate. If after several attempts no response is received, node/device 33 may transmit EBRs using even lower data rates and may ultimately drop all the way to the slowest data rate (e.g., using ROBO mode). Again, any neighboring device in network 100 receiving an EBR should respond with an Enhanced Beacon (EB) using the same data rate as the EBR. At the same time, the receiving neighbor nodes/devices may populate the reduced data rate in their neighbor tables, in accordance with one embodiment.

===Proactive Management of Neighbor Relationships===

A third aspect of the techniques herein involves having devices proactively maintain their neighbor relationships.

In various embodiments, devices that require lower data rates to establish network connectivity must notify the neighbors they choose for routing adjacencies (i.e., attachment routers). In one embodiment, simply receiving a unicast data transmission is sufficient to indicate that the neighbor is interested in maintaining connectivity. As a result, if the registration timeout is longer than the unicast traffic rate from that neighbor, no additional control overhead is required.

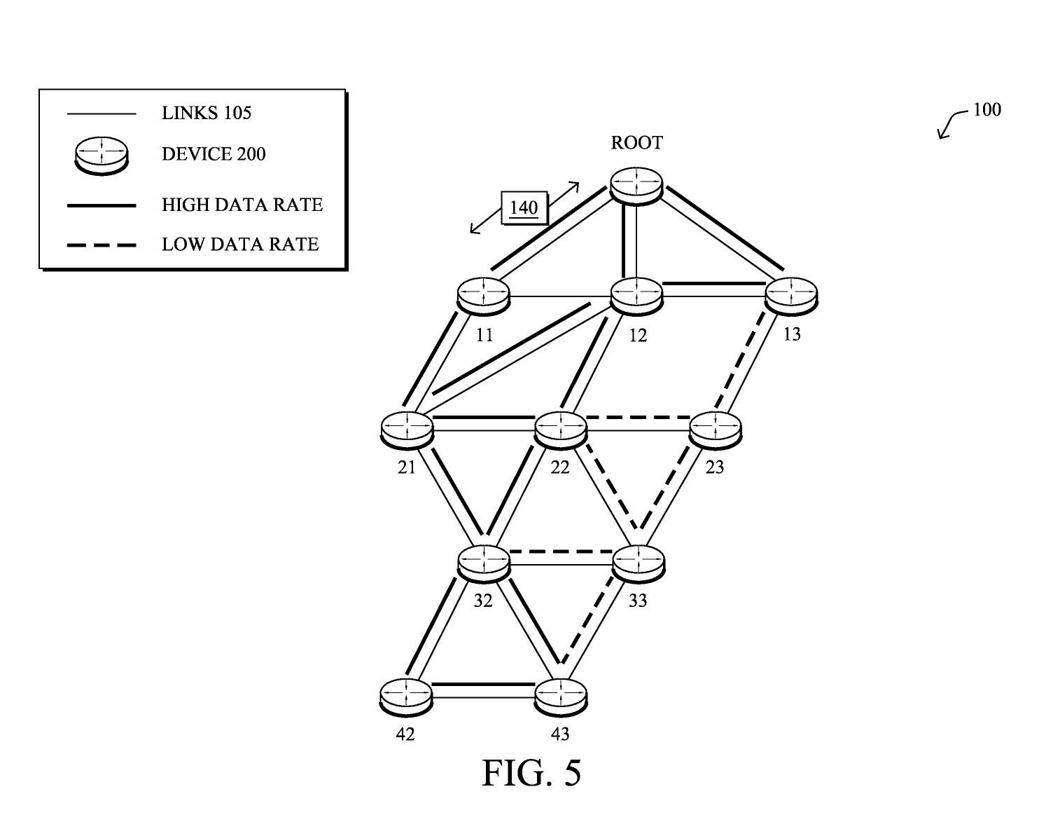

As shown in FIG. 4, for example, assume that node/device 22 receives a unicast data transmission from node/device 33 using the low data rate. In response, node/device 22 may identify node/device 33 in its neighbor table as an attached device. Since the transmission was also received at the lower data rate, node/device 22 may also associate node/device 33 with the lower data rate in its neighbor table. Thus, as shown in the example of FIG. 5, nodes/devices 100 may be configured to proactively maintain their neighbor relationships and information regarding the data rates supported between the nodes/devices. For example, node/device 22 may store data indicative of a low data rate connection with node/device 33 and data indicative of a high data rate connection with node/device 12.

===Broadcasting Using the Lowest Neighbor Data Rate===

A fourth aspect of the techniques described herein involves having devices set their data rate for broadcasts to the minimum data rate of all routing adjacencies.

As shown in the example FIG. 5, a minimum neighbor data rate may be used by each of nodes/devices 200 to ensure that routing updates are received by all interested routing adjacencies, such as when RPL DAG Information Object messages (“RPL DIO” messages) are sent. In one embodiment, only those of nodes 100 that have neighbors needing to operate at a lower data rate will transmit broadcast messages at the lower data rate (e.g., to maintain routing adjacency). The assumption is that a typical Smart Grid AMI deployment will have enough density that most connectivity will be established using the (default) higher data rate and low data rate is only need in exceptional cases. For example, since node/device 22 in FIG. 5 has both low data rate connections (e.g., with nodes/devices 330, 23) and high data rate connections (e.g., with node/device 32, etc.), node/device 22 may broadcast RPL DIO messages to its neighboring devices using the lower data rate. Unicast transmissions in network 100, however, may still operate based on neighbor state, where only low data rate unicast transmissions are used for those neighbors that require it.

===Clustering Low Data Rate Devices===

A fifth aspect of the described techniques involves encouraging low data rate devices to cluster around the same routers.

As noted above, a particular device in network 100 may broadcast messages at a lower data, if it shares a low data rate connection with any of its neighboring devices. Minimizing the number of routers that have neighbors requiring low data rates may increase network performance. In one embodiment, EBs may be sent using a Trickle mechanism, where Trickle's suppression mechanism naturally encourages clustering by minimizing the number of neighbors that respond. In another embodiment, devices may include a node metric that advertises the number of low data rate devices already attached. Devices looking to establish network connectivity with a low data rate then favor routers that have more devices already attached.

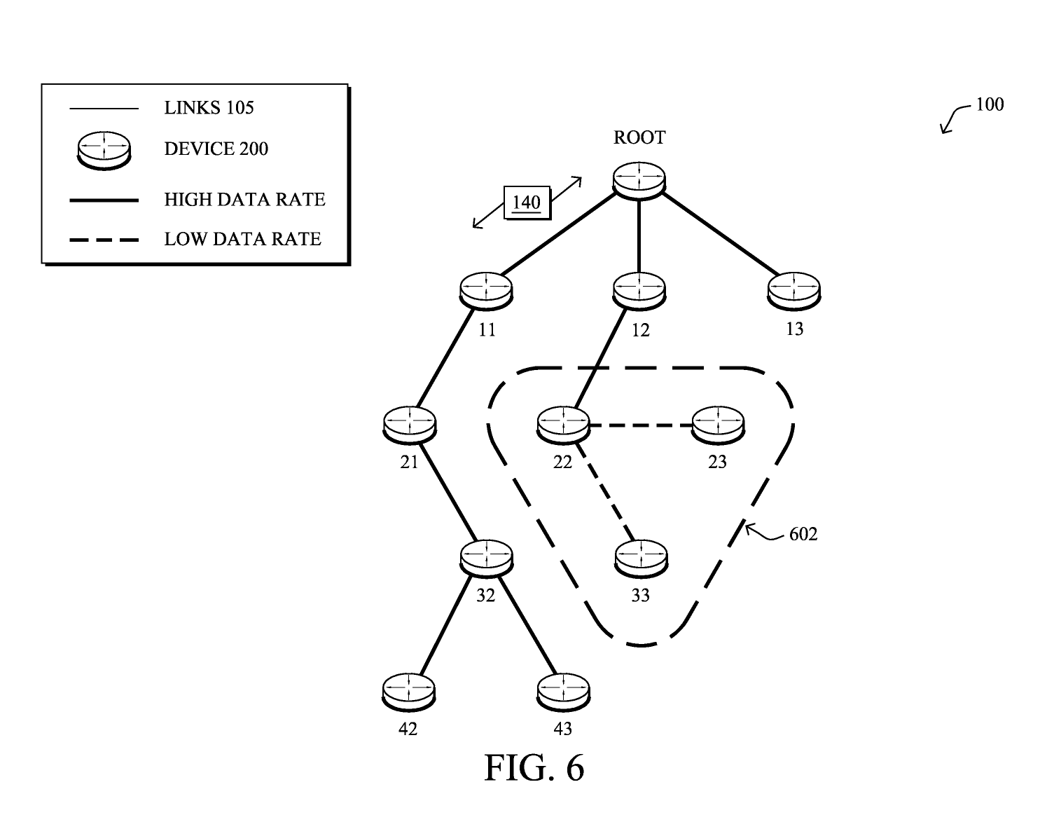

As shown in FIG. 6, for example, network connectivity between devices 200 may be configured such that devices requiring low data rate transmissions are clustered around the same router (e.g., within a constructed DAG). For example, nodes/devices 23 and 33 may both require low data transmission rates with their neighbors. In such a case, nodes/devices 23, 33 may both be attached to node/device 22, thereby forming a cluster 602. Cluster 602 may be formed, in one embodiment, based on node/device 22 advertising to node/device 33 that it already has a low data rate device (e.g., node/device 23) attached to it. In response, node/device 33 may then attach itself to node/device 22 if none of its other neighboring nodes have any low data rate devices attached. In another embodiment, cluster 602 may be formed by suppressing the EBRs send to node/device 33 from its neighbors based on its data rate (e.g., node/device 22 is the only neighbor to send an EBR back to node/device 33).

===Data Rate Reporting===

A sixth aspect of the described techniques involves having devices report information about their neighbor tables to a Field Area Router (i.e., a DAG Root) for different transmission data rates. Using this information, the DAG Root may dynamically choose what the default data rate should be when establishing links. In other words, if the network is too sparse to operate well at a high data rate, the DAG Root may choose to lower the default data rate. When using RPL, the neighbor table information may be provided in RPL DAO messages and the default data rate may be disseminated in RPL DIO messages. Other metrics that a DAG Root may use to determine the default data rate is the path cost (i.e. hops, ETX, etc.), according to various embodiments. For the sake of illustration, this information could be used by the Field Area Router to select the optimum default data rate for various links in the network.

For example, as shown in FIG. 6, each of nodes/devices 200 may report neighbor table data up to the root node/device (e.g., as part of data packets 140). The data received by the root from a given device may include any identified devices that neighbor the sending device, as well as the data rate connections between the device and its neighboring devices. In one embodiment, the root of devices 200 may analyze the received neighbor data to determine a default data rate for network 100. For example, assume that QPSK is used as the default data transmission mode in network 100 and that the data received by the root device indicates that few of devices 200 are actually associated with QPSK. In such a case, the root of network 100 may instruct devices 200 to use BPSK as the default by disseminating this instruction as part of RPL DIO messages to devices 200. In other words, the root may adjust the default data rate upwards or downwards, while still keeping the default data rate above the minimum data rate supported by the network.

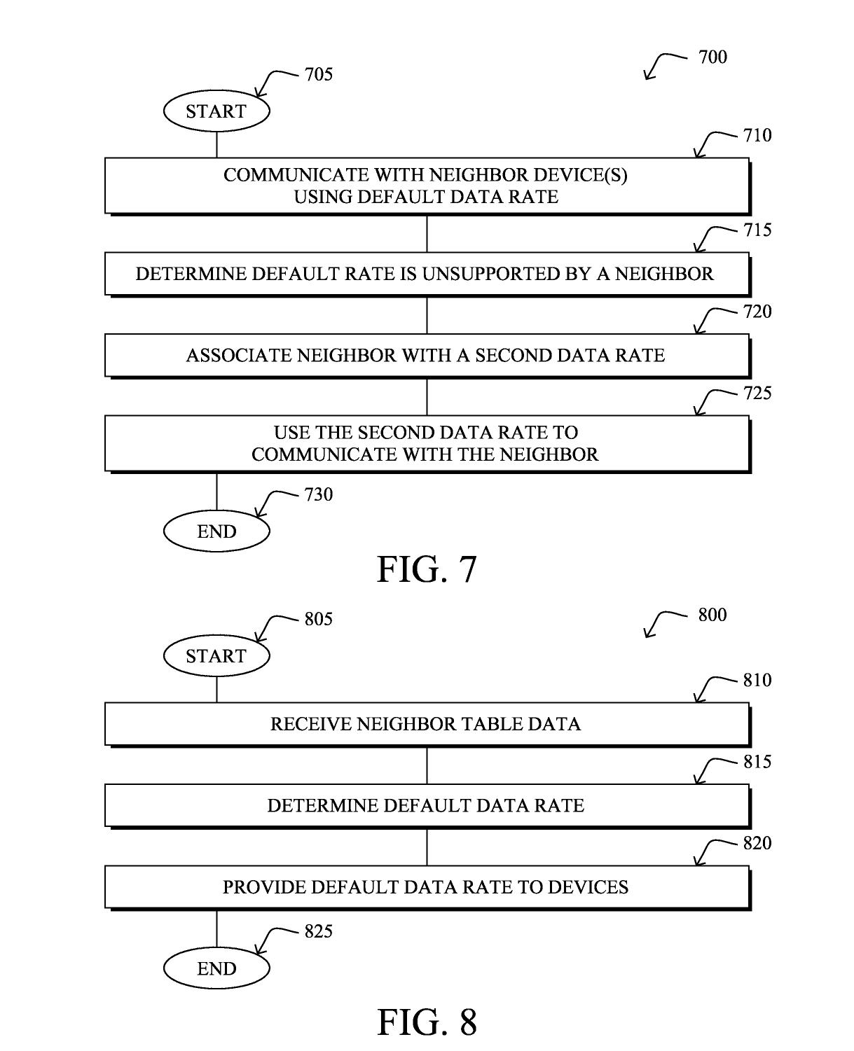

FIG. 7 illustrates an example simplified procedure for selecting a data rate for a neighboring node/device from the perspective of a node/device (e.g., device 200), in accordance with one or more embodiments described herein. The procedure 700 may start at step 705 and continue to step 710 where, as described in greater detail above, a default data rate is used to communicate with one or more neighbor devices. Procedure 700 also includes a step 715 in which a determination is made that a default data rate is unsupported by a neighboring device. For example, as discussed above in various embodiments, a device may determine that the default data rate is unsupported with the neighboring device based on the device receiving a unicast message from the neighbor at a lower data rate. In another example, the device may default data rate is unsupported with the neighbor based on the neighbor not responding to a device discovery request sent at the default data rate. Procedure 700 also includes step 720 in which the neighboring device is associated with a second data rate. In various embodiments, the second data rate is a data rate that is lower than the default data rate used in step 710. At step 725, the second data rate is then used by the device to communicate with the neighboring device and procedure 700 ends at step 730.

FIG. 8 illustrates an example procedure for promulgating a default data rate in a shared-media communication network, from the perspective of a root node/device (e.g., a FAR, etc.) in accordance with one or more embodiments described herein. Procedure 800 begins at step 805 and continues on to step 810 in which neighbor table data is received from one or more nodes/devices under the root node/device in the network. As described above, in some embodiments, the neighbor table data may include information relating to which nodes/devices neighbor a particular node/device in the network, as well as the identified data rates supported between them (e.g., whether the devices only support a lower, non-default data rate). In step 815, the root node/device determines a default data rate for the other nodes/devices based on the received neighbor table data. For example, if the root determines that the network is too sparse to operate well at a high data rate, it may determine a lower, more appropriate data rate should be used by default. In another embodiment, the root may also take into account path costs to determine the default data rate. Procedure 800 then continues on to step 820 in which the default data rate determined in step 815 is provided to the other nodes/devices under the root. For example, as noted above in one embodiment, the root may include the default data rate for the network in RPL DIO messages. Procedure 800 then ends at step 825.

It should be noted that while certain steps within procedures 700-800 may be optional as described above, the steps shown in FIGS. 7-8 are merely examples for illustration, and certain other steps may be included or excluded as desired. Further, while a particular order of the steps is shown, this ordering is merely illustrative, and any suitable arrangement of the steps may be utilized without departing from the scope of the embodiments herein. Moreover, while procedures 700-800 are described separately, certain steps from each procedure may be incorporated into each other procedure, and the procedures are not meant to be mutually exclusive.

The techniques described herein, therefore, provide for a significant performance improvement over the data rate adaptation method currently proposed in IEEE P1901.2 for networks that rely on proactive routing. Unlike reactive networks, proactive networks are much better suited for low-rate periodic reporting that is typical in Smart Grid AMI networks. Low-rate periodic reporting does not offer significant opportunities to amortize the cost of a conservative approach that defaults to using the slowest data rate (e.g., using ROBO). Instead, as discussed in greater detail above, network devices may default to using a high data rate to establish and maintain connectivity, only resorting to a low data rate when needed to establish network connectivity. Accordingly, the number of low data rate transmissions and overhead of sending unneeded Tone Map Request/Reply messages is significantly reduced. Utilizing higher data rates also reduces channel utilization and collisions, especially due to the hidden terminal problem, resulting in a more effective network overall.

While there have been shown and described illustrative embodiments that provide for dynamic enabling of routing devices in a shared-media communication network, it is to be understood that various other adaptations and modifications may be made within the spirit and scope of the embodiments herein. For example, the embodiments have been shown and described primarily herein with respect to two data rates (e.g., a high and a low data rate). Any number of different data rates may be used in other embodiments. In such cases, a network may be defaulted to use any of a set of higher data rates relative to a non-default, lower data rate. In addition, while certain protocols are shown, such as RPL, other suitable protocols may be used, accordingly.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A method, comprising:
communicating, by a device, with one or more neighboring devices in a shared-media communication network using a default data rate;
determining that the default data rate is not supported by a particular one of the neighboring devices;
associating the particular neighboring device with a second data rate, wherein the second data rate comprises a lower data rate than the default data rate; and
using the second data rate to communicate with the particular neighboring device.

2. The method as in claim 1, wherein determining that the default data rate is not supported by the particular neighboring device comprises:
sending a first discovery request to the neighboring device at the default data rate;
determining that a response to the first discovery request was not received from the neighboring device;
sending a second discovery request to the neighboring device using the second data rate; and
receiving a response to the second discovery request from the particular neighboring device using the second data rate.

3. The method as in claim 2, wherein the second discovery request is sent based on a determination that no neighboring devices responded to the first discovery request.

4. The method as in claim 1, further comprising:
storing data regarding the second data rate with an identifier for the neighboring device in a neighbor table.

5. The method as in claim 4, further comprising:
providing the data stored in the neighbor table to a field area router.

6. The method as in claim 1, wherein determining that the default data rate is not supported by a particular one of the neighboring devices comprises:
receiving a unicast message from the particular neighboring device at the second data rate.

7. The method as in claim 1, further comprising:
determining that the second data rate is a minimum data rate associated with any of the neighboring devices; and
sending a broadcast message to the neighboring devices at the second data rate.

8. The method as in claim 7, further comprising:
sending a unicast message to the particular one of the neighboring devices at the second data rate; and
sending another unicast message to a different neighboring device at the default data rate.

9. The method as in claim 1, further comprising:
clustering network devices associated with the second data rate to a set of one or more routers.

10. The method as in claim 1, further comprising:
receiving a node metric from a router that indicates the number of low data rate devices attached to the router; and
attaching to the router based on the node metric.

11. The method as in claim 1, further comprising:
lowering the default data rate in response to an instruction from a field area router in the network to lower the default data rate.

12. An apparatus, comprising:
one or more network interfaces to communicate with a shared-media communication network;
a processor coupled to the network interfaces and configured to execute one or more processes; and
a memory configured to store a process executable by the processor, the process when executed operable to:
communicate with one or more neighboring devices in the network using a default data rate;
determine that the default data rate is not supported by a particular one of the neighboring devices;
associate the particular neighboring device with a second data rate, wherein the second data rate comprises a lower data rate than the default data rate; and
use the second data rate to communicate with the particular neighboring device.

13. The apparatus as in claim 12, wherein the process when executed is further operable to:
send a first discovery request to the neighboring device at the default data rate;
determine that a response to the first discovery request was not received from the neighboring device;
send a second discovery request to the neighboring device using the second data rate; and
receive a response to the second discovery request from the particular neighboring device using the second data rate.

14. The apparatus in claim 13, wherein the second discovery request is sent based on a determination that no neighboring devices responded to the first discovery request.

15. The apparatus as in claim 12, wherein the process when executed is further operable to:
store data regarding the second data rate with an identifier for the neighboring device in a neighbor table.

16. The apparatus as in claim 15, wherein the process when executed is further operable to:
provide the data stored in the neighbor table to a field area router.

17. The apparatus as in claim 12, wherein the process when executed is further operable to:
receive a unicast message from the particular neighboring device at the second data rate.

18. The apparatus as in claim 12, wherein the process when executed is further operable to:
determine that the second data rate is a minimum data rate associated with any of the neighboring devices; and
send a broadcast message to the neighboring devices at the second data rate.

19. A tangible, non-transitory, computer-readable media having software encoded thereon, the software when executed by a processor operable to:
communicate, by a device, with one or more neighboring devices in a shared-media communication network using a default data rate;
determine that the default data rate is not supported by a particular one of the neighboring devices;
associate the particular neighboring device with a second data rate, wherein the second data rate comprises a lower data rate than the default data rate; and
use the second data rate to communicate with the particular neighboring device.

20. A method, comprising:
receiving, at a root node device, neighbor table data from a plurality of devices in a shared-media communication network, the neighbor table data comprising data rates between the devices;
determining a default data rate using the neighbor table data; and
providing the default data rate to the plurality of devices.

21. The method as in claim 20, further comprising:
determining that the network is too sparse to support a current default data rate, wherein the default data rate determined using the neighbor table data has a lower data rate than the current default data rate.

22. The method as in claim 20, wherein the default data rate is determined based in part on path costs between the devices.
